(19) United States
(12) Patent Application Publication
(10) Pub. No.: US 2004/0059744 A1
(43) Pub. Date: Mar. 25, 2004

(54) Data repository system

(75) Inventors: Raymond G. Duncan, Marina del Rey, CA (US); Ronda Lynn F. Dulbandzhyan, Burbank, CA (US); Dinah L. Saperia, Studio City, CA (US); Renier S. Estiandan, North Hills, CA (US); Gary Nakayama, Vans Nuys, CA (US)

Correspondence Address: Pillsbury Winthrop LLP, Intellectual Property Group, 725 South Figueroa Street, Suite 2800, Los Angeles, CA, 90017-5406, US

(73) Assignee: Cedars-Sinai Medical Center, Los Angeles, CA

(21) Appl. No.: 10/247,418

(22) Filed: Sep. 19, 2002

(51) Int. Cl. G06F 17/30

(52) U.S. Cl. 707/102

(57) ABSTRACT

A staging repository includes a message queue table corresponding to a data source to store a message queue transmitted from the data source. A mapping table corresponding to the data source stores relationship information between data fields of the message queue and data fields of at least one schema table. A core program generator retrieves the message queue stored in the message queue table and automatically generates program code in real-time based on the relationship information stored in the mapping table, the fields that are populated in the specific message being processed, and (optionally) an event code included in the message. The program code parses data to be extracted from the data fields of the message queue. A normalized staging schema stores the data extracted by the core program generator into the at least one schema table.

### BACKGROUND OF THE INVENTION

1. Technical Field

The present invention relates to a data repository system. More particularly, the present invention relates to a clinical data repository system that automatically generates program code in real-time to extract data originating from a plurality of data sources having different formats and stores the data in a normalized, relational schema.

2. Discussion of the Related Art

Every health care organization needs an integrated information infrastructure to support a seamless continuum of care. In an average day at a large medical center, more than 30,000 clinical laboratory result records, 4,000 patient demographic records, and 2,000 text reports are processed and loaded into a clinical data repository (CDR). A CDR is a clinical operational data store, which contains detailed patient-centered information, updated in real-time and organized to support quick retrieval. This same data in smaller, department-specific quantities is required in clinical and research databases through the facility. The CDR may receive data from a plurality of data sources, and in the health care context, the data is often transmitted via HL-7 data streams.

The HL-7 standard is used primarily for electronic data exchange in all health care environments. Because of the allowed flexibility in the transfer of information, from a variable number of lines of information to the inconsistent length of each line, coupled with a multitude of applicability, programming a standard interface that can successfully parse through the information and store it in a relational database object requires a lot of customization and specialized code for every data source that is implemented. The data sources are often provided from different vendors and may each include proprietary components, which differ from one vendor system to the next. These differences lead to different data stream formats, as well as requiring different solutions for integration with the main system.

The data stored in the CDR is then accessed by the medical center staff via an interface, such as a terminal or network (Web) interface. By utilizing a CDR, all of the data regarding a patient, obtained from a variety of different departments and sources, may be easily obtained from a single central point.

Due to the differences in format of the data stream from each data source, custom-data source specific program code is required for each available data source to process the data and properly store the data in a logical manner in the CDR. The programming of the program code for each available data source is a long, complex, and tedious process. Therefore, when updates or changes are required, as they routinely are, the entire program code for processing data from each data source, in which there may be 10 or more such data sources in a typical medical center, must be rewritten. After the program code is rewritten for each data source, the program code must be tested to ensure that it is stable and effective, which is also a difficult and time-consuming process.

Accordingly, a real-time data repository system that is flexible, robust, scaleable, minimizes the use of disparate programming languages and technologies, is readily monitored, is easy to support and maintain, contains detailed patient-centered information that is updateable in real-time and organized to support quick retrieval is needed.

### BRIEF DESCRIPTION OF THE DRAWINGS

FIG. 1 illustrates a data repository system according to an embodiment of the present invention;

FIG. 2 illustrates a staging repository in a data repository system according to an embodiment of the present invention;

FIG. 3 is a flow chart diagram illustrating creation of a database repository according to an embodiment of the present invention;

FIG. 4 illustrates a sample HL-7 data stream;

FIG. 5 illustrates a sample message queue;

FIG. 6 illustrates a sample mapping table according to an embodiment of the present invention;

FIG. 7 illustrates a sample event table according to an embodiment of the present invention;

FIGS. 8A and 8B illustrate a sample program code generated for populating a schema table with data extracted from a message queue according to an embodiment of the present invention;

FIG. 9 illustrates a sample entry generated for a schema table according to an embodiment of the present invention; and

FIG. 10 illustrates a sample partial normalized staging schema for an admission, discharge, transfer (ADT) staging repository according to an embodiment of the present invention.

### DETAILED DESCRIPTION

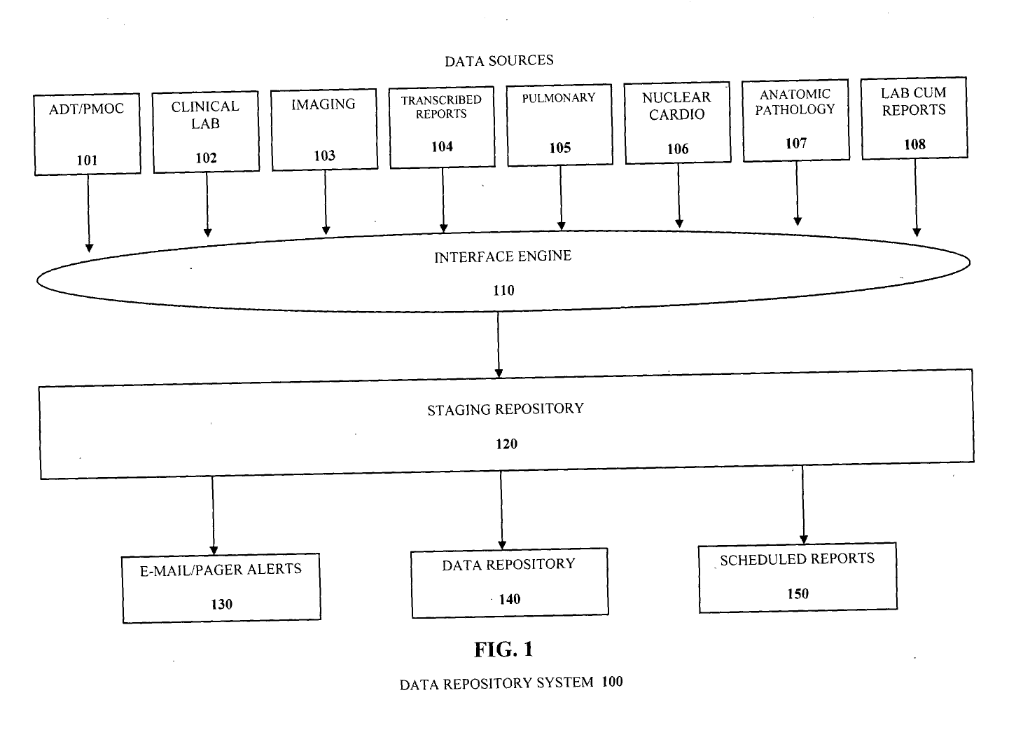

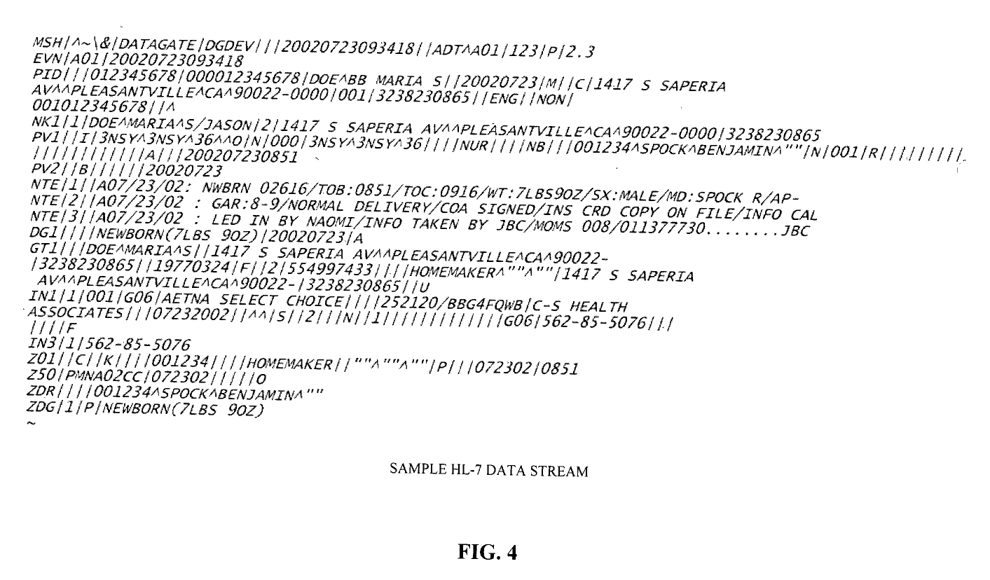

FIG. 1 illustrates a data repository system according to an embodiment of the present invention. Data sources 101-108 from a variety of different departments of, for example, a medical center, provide data regarding patients. In the example illustrated in FIG. 1, the data sources may include: admissions/discharge/transfer (ADT/PMOC) 101, clinical laboratory 102, imaging 103, transcribed reports 104, pulmonary 105, nuclear cardiology 106, anatomic pathology 107, and laboratory cumulative reports 108. However, any greater or lesser number of data sources, and also those providing different types of data, may also be implemented. The data provided from these data sources 101-108 are typically in the HL-7 format (see FIG. 4), but the data sources 101-108 may provided data in any suitable format, including file transfer protocol (FTP) batch files, hypertext markup language (HTML) files, extended markup language (XML) files, script (e.g., Oracle script) files, etc.

Preferably, the data from each data source 101-108 is received by an interface engine 110 or translator. However, it is possible that some data sources may bypass the interface engine 110 and provide data directly to the staging repository 120. The interface engine 110 translates the data received from each data source 101-108 into a common format or structure for processing by the staging repository 120. According to an embodiment of the present invention, the interface engine 110 may be a SeeBeyond Technologies Corporation (STC) DataGate interface engine, but any suitable interface module may be utilized. Referring to FIG. 4, which is a sample HL-7 data stream provided by the ADT data source 101, the interface engine 110 translates these lines of text of data into a message queue suitable for storage in a table format.

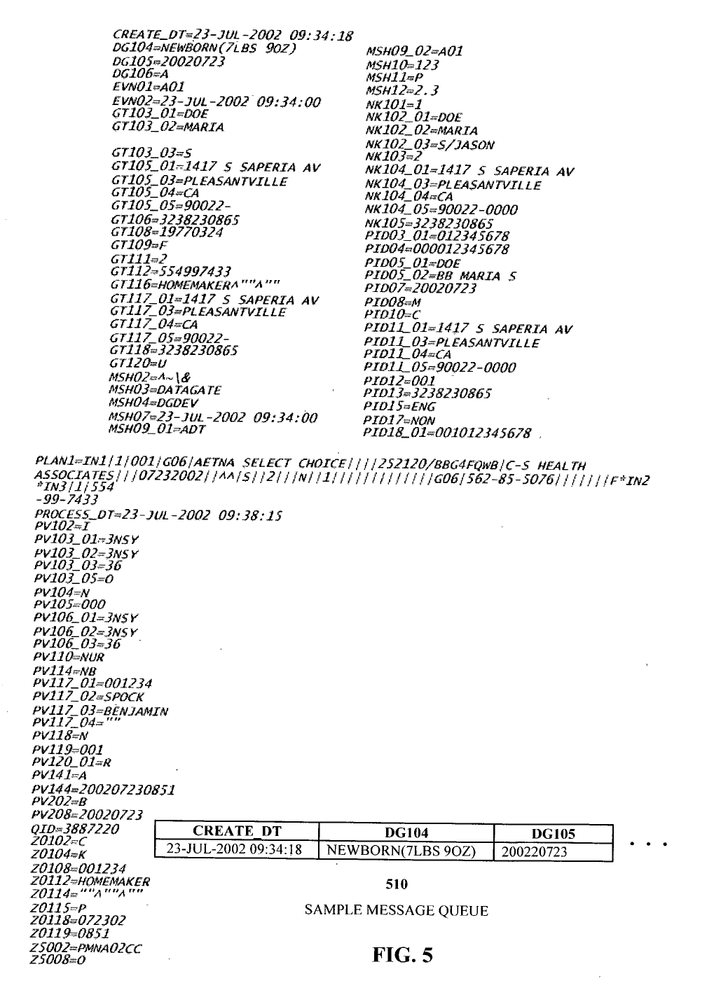

The interface engine 110 translates the HL-7 data stream into a message queue 510 (see FIG. 5), which is a row of data having a plurality of columns or data fields. The data listed in FIG. 5 correspond to a column/data field and its corresponding value. A plurality of message queues 510 may be assembled to form a message queue table, in which each row of the table is a separate message queue 510. Once the interface engine 110 translates the data received from a data source 101-108 into a message queue 510, the message queue is transmitted to the staging repository 120 for processing.

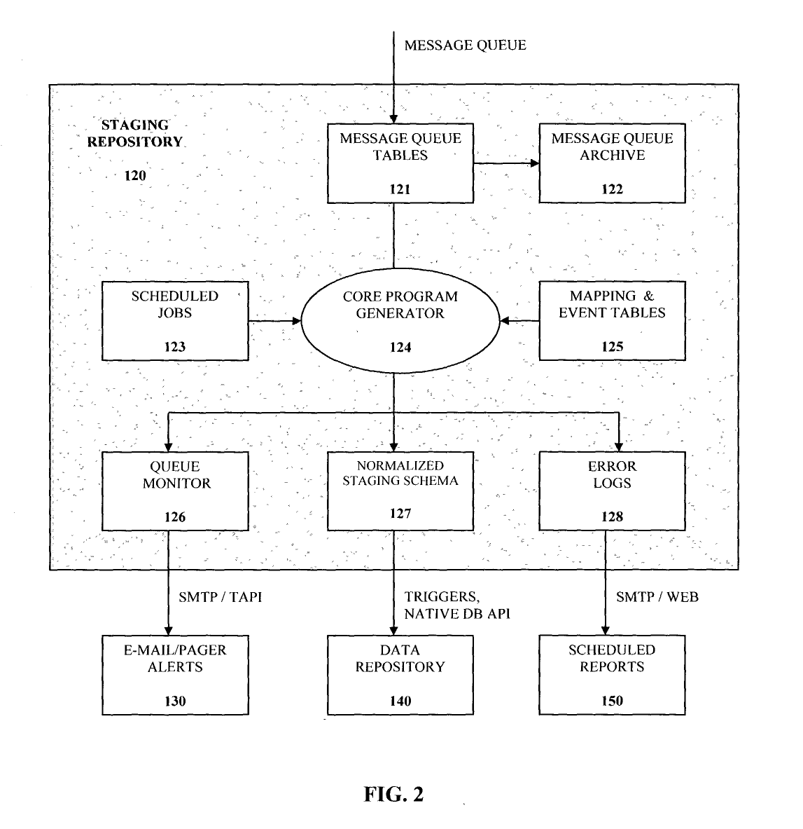

FIG. 2 illustrates a staging repository in a data repository system according to an embodiment of the present invention. The staging repository 120 includes message queue table(s) 121 to store message queues 510 received from the interface engine 110. In a preferred embodiment of the present invention, there is a message queue table 121 corresponding to each one of the data sources 101-108. However, it is possible to store message queues from each data source 101-108 in a single message queue table 121 as well. Each message queue table 121 may also have a corresponding message queue archive 122, which stores each message queue 510 received by the staging repository 120 for later reference and archival purposes. According to another embodiment of the present invention, a staging repository 120 corresponding to each data source 101-108 may be provided.

Parsing the information (transferring the data from source to destination) from message queues is quite complex, especially when: (1) all data elements of the source cannot be expected to be populated every time; (2) a data element of the source may be mapped to multiple destination tables/columns; (3) the destination tables/columns involved is dependent on the data being passed; (4) the data manipulation statement (e.g., insert or update) involved is dependent on the data being passed; and (5) validation of data before any transaction can occur is required.

At the heart of the staging repository 120 is the core program generator 124. The core program generator 124 dynamically generates program code in real-time specific for each message queue 510 to be processed. The core program generator 124 is preferably a dynamic structured query language (SQL) module. Dynamic SQL permits the writing of a SQL statement that is capable of writing and executing more SQL statements. Dynamic SQL is useful in automating repetitive tasks, writing code that works in any database or server, and writing code that dynamically adjusts itself to changing conditions. Typically, dynamic SQL is driven off of system tables. Unlike static SQL statements, dynamic SQL statements are not embedded in a source program. Rather, dynamic SQL statements are stored in character strings input to or built by the program at run time. Dynamic SQL statements may be entered interactively or read from a file. However, any suitable program generating routine for the core program generator 124 other than dynamic SQL may be utilized, though.

The core program generator 124 retrieves a message queue 510 from a message queue table 121 and utilizes a mapping table 125 to dynamically generate the program code to parse data to be extracted from the message queue 510. In other words, the core program generator 124 automatically generates the program code (executable statements) to parse the message queue 510 based on entries in a corresponding mapping table 125. A scheduled jobs 123 module may be provided to monitor the incoming data to the staging repository 120, provide alarm functions, send calls at different intervals to each data source 101-108 for data, etc.

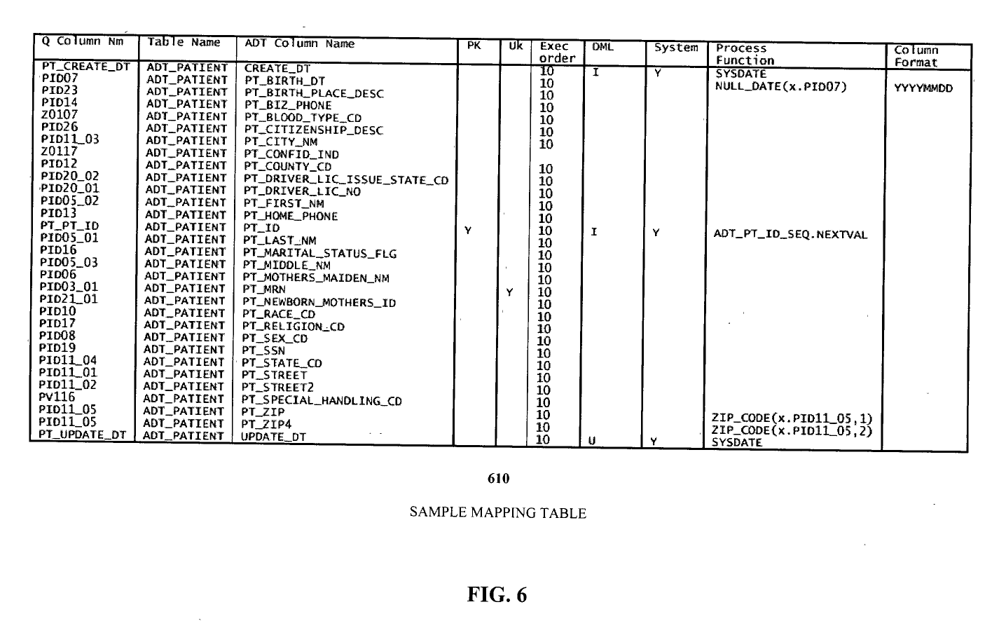

In a preferred embodiment of the present invention, each data source 101-108 has a corresponding mapping table 610 (see FIG. 6). In the sample mapping table 610 illustrated in FIG. 6, each entry in the table addresses provides: (1) basic mapping of each source element to the destination; (2) data conversion of each element as it is copied over to the destination; (3) validation of data; (4) enforcement of integrity constraint on the database objects; (5) order of execution of the statements generated; and (6) which statements are valid to be executed based on the data. The sample mapping table 610 illustrated in FIG. 6 provides entries for the dynamic generation of program code in real-time for the populating an ADT_PATIENT schema table. The top lines in the mapping table 610 of FIG. 6 are column identifiers and the succeeding lines are records and values for each column.

For example, the “Q Column Nm” column identifies the data fields in the message queue 510, where the source information exists. The “Table Name” and “ADT Column Name” columns identify the destination table (schema table) and column name, respectively. This relationship information is where the mapping of the source and destination are identified. The “Pk” and “Uk” columns stand for “Primary Key” and “Unique Key”, respectively, and are consecutively utilized by the core program generator 124 to effectively build insert and/or update statements dynamically, ensuring that the constraints of the database are maintained. The “Exec Order” column defines the order that these entries as a whole are to be processed in reference to other tables that need to be populated (hence a single value for this set of records). The “DML” column defines whether the destination column is included in the insert statement and/or update statement. The “System” column defines whether a function has been built in place of the raw source column. The “Process Function” column determines if data transformation and/or validation is performed, and defines whether the insert/update statement dynamically built is to be executed. The “Column Format” column provides template conversion of text data into, for example, a data format, as the source values are all string values. Although the mapping table 610 of FIG. 6 is for generation of program code by the core program generator 124 to populate the ADT_PATIENT schema table, the mapping table 610 may include entries to populate other schema tables; or different mapping tables corresponding to a data source 101-108 may be utilized to populate different schema tables. Old data in the schema tables may be retained with new data (i.e., preserving historical data), or the new data may overwrite the old data, depending on the type of data that is to be stored.

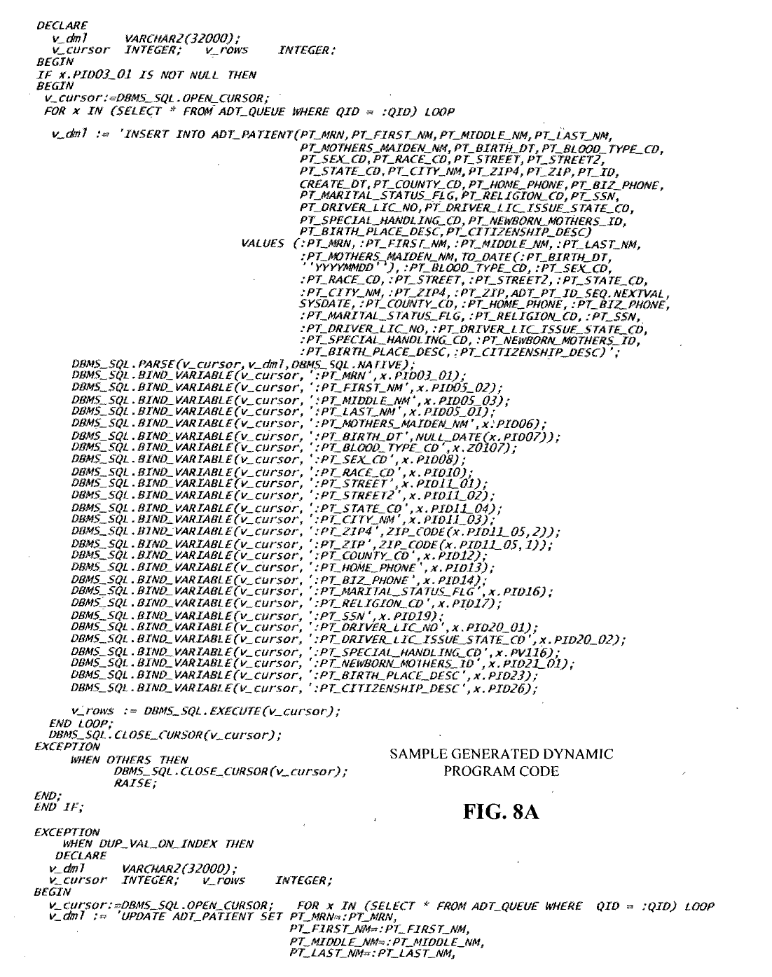

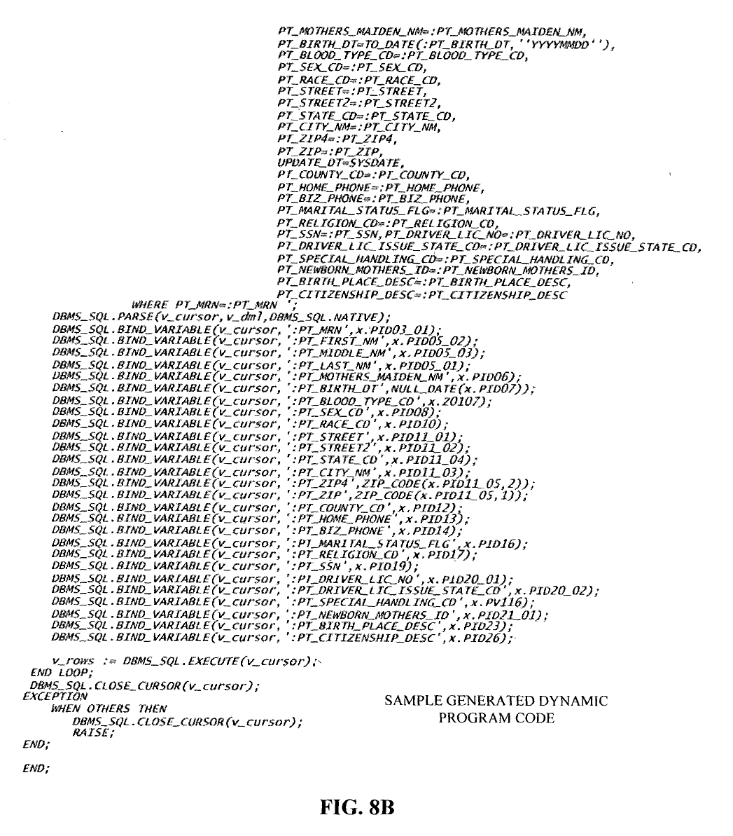

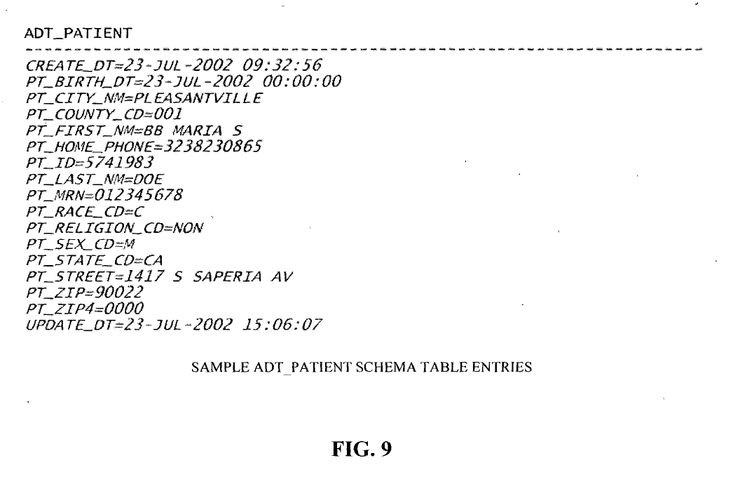

The core program generator 124 reads the entries from the mapping table 610 in FIG. 6 and dynamically generates program code (see FIGS. 8A and 8B) in real-time to populate the ADT_PATIENT schema table by extracting data from the message queue 510. Upon execution of the dynamic program code (e.g., SQL statements) generated by the core program generator 124, the source information from the message queue 510 is populated in the destination schema table (ADT_PATIENT, see FIG. 9) within a normalized relational staging schema 127. Any errors that may have occurred during the parsing of the data by the core program generator 124, such as missing data, malformed data, etc., may be stored in error logs 128 so that troubleshooting of the system may be performed if required. The error logs 128 may be in the form of tables much like the structure of the message queue tables 121. The error logs 128 may be forward to scheduled reports 150 generated regarding the status of the overall system 100 and any other administrative details and data to be collected for upkeep of the system 100. Some data from the data source 101-108 may be flagged for immediate transmission upon processing, and such data are forward to the queue monitor 126. The queue monitor 126 in turn forwards the flagged data to the requesting person, via e-mail, pager alerts, telephone calls, facsimile, etc.

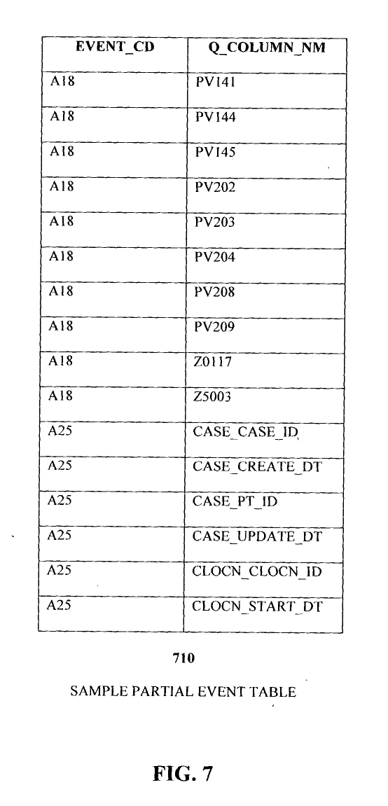

The core program generator 124 may utilize an event table 710 (see FIG. 7) in conjunction with a mapping table 125 to dynamically generate program code to parse the message queue 510. The event table 710 further qualifies and disqualifies which pieces of data from the message queue 510 should be processed. In the sample event table 710 illustrated in FIG. 7, the “EVENT_CD” column defines an event code (e.g., an HL-7 event code); and the “Q_COLUMN NM” column defines the name of the column in the message queue that is affected by the event code (e.g., HL-7 event code). In other words, the event table 710 determines for a specific event (code) which particular set(s) of data to process. For example, the HL-7 event code for “A18” means “merge patient information”, and the HL-7 event code for “A25” means “cancel pending discharge” in the context of the ADT data source 101.

By implementing the event table 710 with the mapping table 610, for example, different business rules (for data validation) may be implemented for messages that are otherwise essentially identical. For example, the ADT data source 101 generates essentially identical data messages for an “Admit” event (e.g., a patient coming into the hospital) and a “Transfer” event (e.g., a patient being moved from one bed to another). Utilizing the combination of the event table 710 with the mapping table 610, when processing an “Admit” event, as an added layer of data validation, a restriction is imposed in that a previous record for that particular case number does not exist. When processing a “Transfer” event, as an added layer of data validation, a restriction is imposed in that a previous record for that particular case number must exist. The event table 710, utilized in combination with the mapping table 610, further ensures that the data extracted from the data messages is accurate and valid.

According to one embodiment of the present invention, once the program code has finished parsing and extracting the data from the message queue 510, the program code is discarded, and the core program generator 124 is ready to dynamically generate a new program code for another message queue 510 to be processed.

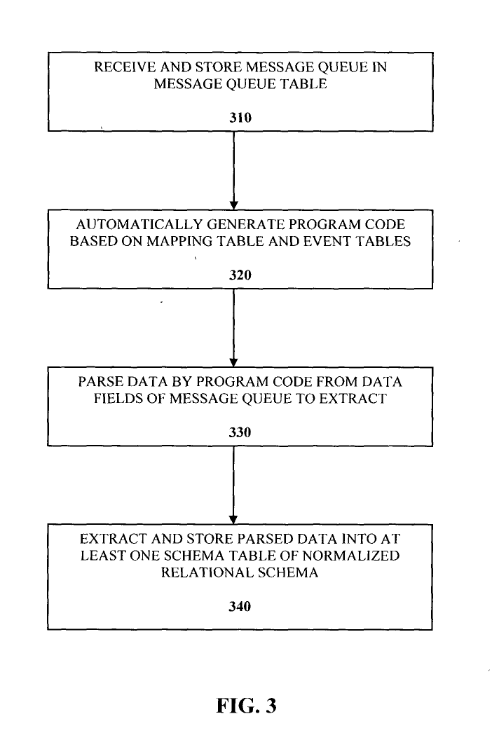

FIG. 3 is a flow chart diagram illustrating creation of a database repository according to an embodiment of the present invention. The staging repository 120 receives and stores 310 a message queue 510 in a message queue table 121. The core program generator 124 retrieves the message queue 510 from the message queue table 121 and automatically generates 320 program code in real-time based on relationship information stored in a mapping table 125. An event table 710 (see FIG. 7) may also be utilized in conjunction with the mapping table 125 to facilitate dynamic generation of the program code. The relationship information identifies a mapping of the source and destination, and in particular, between data fields of the message queue and the data fields of at least one schema table. The entries from the mapping table 125 and the event table 710 are preferably stored in program arrays of the program code dynamically generated by the core program generator 124.

For each message queue 510 processed, the mapping information in the mapping table 125 (and the event information in the event table 710) are utilized by the core program generator 124 to create, preferably, a dynamic SQL statement program code. In a preferred embodiment of the present invention, the dynamic SQL statement attempts to insert a record into a schema table. If the insert command fails due to a duplicate key, then a new dynamic SQL statement attempts to update the record in the schema table. If any errors occur during the dynamic SQL statement processing (except for a duplicate key error), an error is raised and the message queue 510 may be written to an error queue table. The SQL error and dynamic SQL statement may be stored in an error log 128 or error log table. After all message queues in the message queue table 121 are processed, statistics regarding the processing may be written into a queue log. The program code parses 330 data from the data fields of the message queue 510 and extracts 340 and stores the parsed data into at least one schema table.

Accordingly, without utilizing a core program generator 124 to dynamically generate program code to parse the message queues 510, all expected scenarios must be manually coded in a program, which is a complicated, long, and tedious process. Moreover, utilizing the core program generator 124 requires that any changes or updates may be performed by modifying the mapping table (and/or the event table), which is an easier and faster process than writing program code for each available data source 101-108.

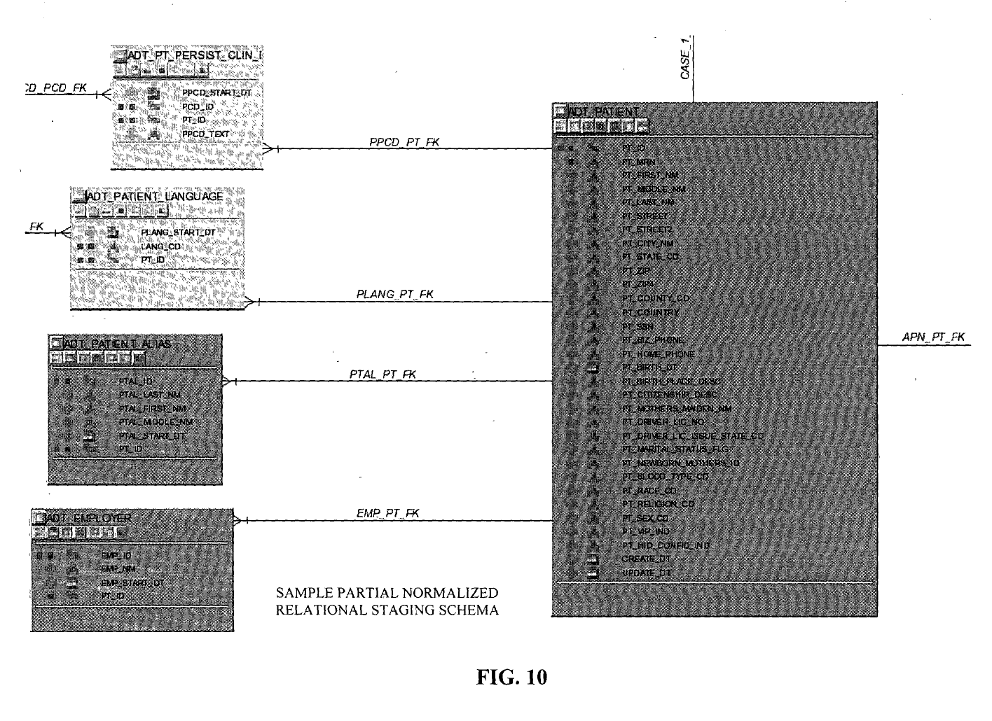

FIG. 10 illustrates a sample partial normalized staging schema for an admission, discharge, transfer (ADT) staging repository according to an embodiment of the present invention. FIG. 10 illustrates an ADT_PATIENT schema table (see also FIG. 9), in relation to an ADT_PT_PERSIST_CLIN_DATA schema table, an ADT_PATIENT_LANGUAGE schema table, an ADT_PATIENT_ALIAS schema table, and an ADT_EMPLOYER schema table. These schema tables are just representative examples of a plurality of schema tables making up the normalized relational staging schema 127 for the ADT data source 101. As mentioned above, each data source 101-108 may have a corresponding staging repository 120; that is, there is a staging repository 120 having a message queue table 121, a mapping table 125, a core program generator 124, a normalized relational staging schema 127, etc. for each data source 101-108 available. A single staging repository 120 may also be utilized for all of the data sources 101-108.

The schema tables in the normalized relational staging schema 127, in which each data source 101-108 may have a corresponding normalized relational staging schema 127, may be further “pushed” down to a data repository (or CDR) 140, which is a giant database of all the data stored for a patient, for example, which provides a single central point for which a doctor may provide direct patient care. The data repository 140 may be a larger normalized relational schema (e.g., a data repository normalized relational schema) of which the normalized relational staging schema 127 in the staging repository 120 is a subset. The data repository 140 may include schema tables for a plurality of data sources 101-108.

Although the data repository system 100 discussed above is mainly in the health care context, the data repository system 100 may be utilized with a number of different environments and applications outside of health care. The data repository system 100 of the present invention may be implemented in any database system, or any environment in which rapid, efficient, and accurate storage and retrieval of data is required.

While the description above refers to particular embodiments of the present invention, it will be understood that many modifications may be made without departing from the spirit thereof. The accompanying claims are intended to cover such modifications as would fall within the true scope and spirit of the present invention. The presently disclosed embodiments are therefore to be considered in all respects as illustrative and not restrictive, the scope of the invention being indicated by the appended claims, rather than the foregoing description, and all changes that come within the meaning and range of equivalency of the claims are therefore intended to be embraced therein.

What is claimed is:

1. A staging repository, comprising:
a message queue table corresponding to a data source to store a message queue transmitted from the data source;
a mapping table corresponding to the data source storing relationship information between data fields of the message queue and data fields of at least one schema table;
a core program generator to retrieve the message queue stored in the message queue table and to automatically generate program code in real-time based on the relationship information stored in the mapping table, wherein the program code parses data to be extracted from the data fields of the message queue; and
a normalized relational staging schema to store the data extracted by the core program generator into the at least one schema table.

2. The staging repository according to claim 1, wherein the message queue is formed from a data message transmitted from the data source.

3. The staging repository according to claim 2, wherein the data message is an HL-7 data message.

4. The staging repository according to claim 1, further including a message queue archive to receive and store message queues received by the message queue table.

5. The staging repository according to claim 1, wherein the core program generator utilizes dynamic Structured Query Language (SQL).

6. The staging repository according to claim 1, wherein the message queue is a row having a plurality of columns for each one of the data fields.

7. The staging repository according to claim 1, wherein the program code is discarded after processing of the message queue.

8. A data repository system, comprising:
an interface engine to receive a data message from a data source and to generate a message queue based on the data message;
a staging repository having
a message queue table corresponding to the data source to store the message queue received from the interface engine,
a mapping table corresponding to the data source storing relationship information between data fields of the message queue and data fields of at least one schema table,
a core program generator to retrieve the message queue stored in the message queue table and to automatically generate program code in real-time based on the relationship information stored in the mapping table, wherein the program code parses data to be extracted from the data fields of the message queue, and
a normalized relational staging schema to store the data extracted by the core program generator into the at least one schema table; and
a data repository to access and store the normalized relational staging schema into a data repository schema.

9. The data repository system according to claim 8, further including a message queue archive to receive and store message queues received by the message queue table.

10. The data repository system according to claim 8, wherein the data message is an HL-7 data message.

11. The data repository system according to claim 8, wherein the core program generator utilizes dynamic Structured Query Language (SQL).

12. The data repository system according to claim 8, wherein the message queue is a row having a plurality of columns for each one of the data fields.

13. The data repository system according to claim 8, wherein the program code is discarded after processing of the message queue.

14. A data repository system, comprising:
a plurality of data sources;
an interface engine to receive a data message from one of the plurality of data sources and to generate a message queue based on the data message;
a staging repository having
a plurality of message queue tables, wherein each one of the plurality of data sources has a corresponding message queue table, and the message queue is received and stored in the corresponding message queue table to the one of the plurality of data sources that transmitted the data message,
a plurality of mapping tables, wherein each one of the plurality of data sources has a corresponding mapping table, and each one of the plurality of mapping tables includes relationship information between data fields of the message queue and data fields of at least one schema table,
a core program generator to retrieve the message queue stored in the plurality of message queue tables and to automatically generate program code in real-time based on the relationship information of the corresponding mapping table to the one of the plurality of data sources that transmitted the data message, wherein the program code parses data to be extracted from the data fields of the message queue, and
a normalized relational staging schema to store the data extracted by the core program generator into the at least one schema table; and
a data repository to access and store the normalized relational staging schema into a data repository schema.

15. The data repository according to claim 14, further including a message queue archive to receive and store message queues received by the plurality of message queue tables.

16. The data repository according to claim 14, wherein the data message is an HL-7 data message.

17. The data repository according to claim 14, wherein the core program generator utilizes dynamic Structured Query Language (SQL).

18. The data repository according to claim 14, wherein the message queue is a row having a plurality of columns for each one of the data fields.

19. The data repository according to claim 14, wherein the program code is discarded after processing of the message queue.

20. A staging repository, comprising:
a plurality of message queue tables, wherein each one of a plurality of data sources has a corresponding message queue table, and a message queue based on a data message is received and stored in the corresponding message queue table to the one of the plurality of data sources that transmitted the data message;
a plurality of mapping tables, wherein each one of the plurality of data sources has a corresponding mapping table, and each one of the plurality of mapping tables includes relationship information between data fields of the message queue and data fields of at least one schema table;
a core program generator to retrieve the message queue stored in the plurality of message queue tables and to automatically generate program code in real-time based on the relationship information of the corresponding mapping table to the one of the plurality of data sources that transmitted the data message, wherein the program code parses data to be extracted from the data fields of the message queue; and
a normalized relational staging schema to store the data extracted by the core program generator into the at least one schema table.

21. The staging repository according to claim 20, further including a message queue archive to receive and store message queues received by the plurality of message queue tables.

22. The staging repository according to claim 20, wherein the data message is an HL-7 data message.

23. The staging repository according to claim 20, wherein the core program generator utilizes dynamic Structured Query Language (SQL).

24. The staging repository according to claim 20, wherein the message queue is a row having a plurality of columns for each one of the data fields.

25. The staging repository according to claim 20, wherein the program code is discarded after processing of the message queue.

26. A method of creating a database, comprising:
receiving and storing a message queue in a message queue table corresponding to a data source that transmitted the message queue;
retrieving the message queue from the message queue table and automatically generating program code in real-time based on relationship information, between data fields of the message queue and data fields of at least one schema table, stored in a mapping table corresponding to the data source that transmitted the message queue;
parsing, by the program code, data to be extracted from the data fields of the message queue; and
extracting and storing the data from the data fields of the message queue parsed by the program code into the at least one schema table of a normalized relational staging schema.

27. The method according to claim 26, further including receiving and storing message queues received by the message queue table in a message queue archive.

28. The method according to claim 26, further including generating the message queue from an HL-7 data message.

29. The method according to claim 26, further including utilizing dynamic Structured Query Language (SQL) for automatically generating the program code in real-time.

30. The method according to claim 26, wherein the message queue is a row having a plurality of columns for each one of the data fields.

31. The method according to claim 26, further including discarding the program code after the message queue is processed.

32. An instruction code storage device, comprising:
a machine-readable storage medium; and
machine-readable instruction code, stored on the machine-readable storage medium, having instructions to
receive and store a message queue in a message queue table corresponding to a data source that transmitted the message queue,
retrieve the message queue from the message queue table and automatically generate program code in real-time based on relationship information, between data fields of the message queue and data fields of at least one schema table, stored in a mapping table corresponding to the data source that transmitted the message queue,
parse, by the program code, data to be extracted from the data fields of the message queue, and
extract and store the data from the data fields of the message queue parsed by the program code into the at least one schema table of a normalized relational staging schema.

33. The instruction code storage device according to claim 32, wherein the instruction code further includes instructions to receive and store message queues received by the message queue table in a message queue archive.

34. The instruction code storage device according to claim 32, wherein the instruction code further includes instructions to generate the message queue from an HL-7 data message.

35. The instruction code storage device according to claim 32, wherein the instruction code further includes instructions to utilize dynamic Structured Query Language (SQL) to automatically generate the program code.

36. The instruction code storage device according to claim 32, wherein the message queue is a row having a plurality of columns for each one of the data fields.

37. The instruction code storage device according to claim 32, wherein the instruction code further includes instructions to discard the program code the message queue is processed.

38. A data repository system, comprising:
a plurality of data sources;
an interface engine to receive a data message from one of the plurality of data sources and to generate a message queue based on the data message;
a plurality of staging repositories, wherein each one of the plurality of data sources has a corresponding staging repository, and each one of the plurality of staging repositories includes
a message queue table to store the message queue received from the interface engine,
a mapping table to store relationship information between data fields of the message queue and data fields of at least one schema table,
a core program generator to retrieve the message queue stored in the message queue table and to automatically generate program code in real-time based on the relationship information stored in the mapping table, wherein the program code parses data to be extracted from the data fields of the message queue, and
a normalized relational staging schema to store the data extracted by the core program generator into the at least one schema table; and
a data repository to access and store each normalized relational staging schema of the plurality of staging repositories into a data repository schema.

39. The data repository system according to claim 38, wherein each one of the plurality of staging repositories further includes a message queue archive to receive and store message queues received by the message queue table.

40. The data repository system according to claim 38, wherein the data message is an HL-7 data message.

41. The data repository system according to claim 38, wherein the core program generator utilizes dynamic Structured Query Language (SQL).

42. The data repository system according to claim 38, wherein the message queue is a row having a plurality of columns for each one of the data fields.

43. The data repository system according to claim 38, wherein the program code is discarded after processing of the message queue.
